(19) United States
(12) Patent Application Publication
(10) Pub. No.: US 2015/0148508 A1
(43) Pub. Date: May 28, 2015

(54) (METH) ACRYLIC RESIN COMPOSITION

(71) Applicant: KURARAY CO., LTD., Kurashiki-shi, Okayama (JP)

(72) Inventors: Takuro Niimura, Tainai-shi (JP); Hiroyuki Konishi, Tainai-shi (JP); Hiroshi Ozawa, Tainai-shi (JP); Hidemi Kurita, Chiyoda-ku (JP); Hideyuki Tamura, Tsukuba-shi (JP)

(73) Assignee: KURARAY CO., LTD., Kurashiki-shi, Okayama (JP)

(21) Appl. No.: 14/397,366

(22) PCT Filed: Apr. 22, 2013
(86) PCT No.: PCT/JP2013/002713

§ 371 Date: Oct. 27, 2014

(30) Foreign Application Priority Data
Apr. 27, 2012 (JP) 2012-103788

(51) Int. Cl. C08J 5/00

(52) U.S. Cl. CPC C08J 5/00; C08J 2333/12
USPC 526/328.5

(57) ABSTRACT

A (meth)acrylic resin composition comprising not less than 99.5% by mass of (meth)acrylic resin composed of 80 to 100% by mass of a structural unit derived from methyl methacrylate and 0 to 20% by mass of a structural unit derived from acrylic acid ester, wherein a difference between YI4 and YI1 is not more than 3, in which the YI4 is a yellowness index at optical path length 200 mm of an article obtained by injection molding of the (meth)acrylic resin composition at a cylinder temperature of 280° C. and a molding cycle of 4 minutes, and the YI1 is a yellowness index at optical path length 200 mm of an article obtained by injection molding of the (meth)acrylic resin composition at a cylinder temperature of 280° C. and a molding cycle of 1 minute; and the (meth)acrylic resin composition has a melt flow rate under conditions of 230° C. and 3.8 kg load of not less than 25 g/10 min.

### TECHNICAL FIELD

The present invention relates to a (meth)acrylic resin composition. More specifically, the present invention relates to a (meth)acrylic resin composition that can give a large-area thin molded article having little residual distortion and little discloration at high production efficiency even by injection molding performed at a low cylinder temperature and a high injection pressure.

### BACKGROUND ART

A light guide plate as a component of a liquid crystal display is produced, for example, by injection molding of a resin composition containing a transparent resin such as a (meth)acrylic resin (see Patent Document 1). In recent years, large-area lightweight liquid crystal display devices are highly demanded, and along with this trend, larger-area thiner light guide plates are required.

Generally, injection molding to give a large-area thin molded article needs to be performed at a high injection pressure and a high cylinder temperature. High injection pressure and low cylinder temperature tend to give a molded article having residual distortion, and the molded article sometimes changes in dimensions and/or warps when heated during use. On the other hand, low injection pressure and high cylinder temperature may sometimes make a molded article discolored to impair its transparency.

Approaches known for inhibiting discoloration caused by heat at the time of heating and melting are addition of an organic disulfide compound such as di-t-dodecyl disulfide to a methacrylic resin (see Patent Document 2), or addition of an organic disulfide compound and an organic silicon compound such as 1,1,2,2-tetraphenyl disilane (see Patent Document 3). Patent Document 4 suggests addition of a commercially available phenol-based antioxidizing agent and a commercially available phosphorus-based antioxidizing agent to a copolymer comprising a methyl methacrylate unit, an N-substituted maleimide unit, and a cyclohexyl methacrylate unit. Patent Document 4 also suggests addition of a phosphorous acid ester such as nonylphenyltridecylpentaerythritol diphosphite, bis(nonylphenyl)pentaerythritol diphosphite, and distearylpentaerythritol diphosphite to a resin comprising an N-isopropylmaleimide unit and/or an N-cyclohexylmaleimide unit.

### PRIOR ART LIST

### Patent Literatures

Patent Document 1: JP H09-31134 A
Patent Document 2: JP 2006-104376 A
Patent Document 3: JP 2006-104377 A
Patent Document 4: JP H09-169883 A
Patent Document 5: JP H06-116331 A

### NON PATENT LITERATURES

Non-Patent Document 1: Technical data from Nippon Oil & Fats Co., Ltd. “Hydrogen abstraction capacity and efficiency as initiator of organic peroxides” (prepared on April, 2003)

### SUMMARY OF THE INVENTION

### Problems to be Solved by the Invention

None of these approaches thus suggested in the prior art documents, however, is fully satisfactory because of the low productivity, inadequate resistance to weathering, poor appearance of the resulting molded article, poor control over discoloration caused by heat, or the like.

Therefore, an object of the present invention is to provide a (meth)acrylic resin composition that can give a large-area thin molded article having little residual distortion and little discoloration at high production efficiency even by injection molding performed at a low cylinder temperature and a high injection pressure.

### Means for Solving the Problems

The inventors of the present invention conducted intensive research to achieve the object and, as a result, completed the present invention that includes the following embodiments.

[1] A (meth)acrylic resin composition comprising

not less than 99.5% by mass of (meth)acrylic resin composed of 80 to 100% by mass of a structural unit derived from methyl methacrylate and 0 to 20% by mass of a structural unit derived from an acrylic acid ester, wherein

a difference between YI4 and YI1 is not more than 3, in which the YI4 is a yellowness index at optical path length 200 mm of an article obtained by injection molding of the (meth)acrylic resin composition at a cylinder temperature of 280° C. and a molding cycle of 4 minutes, and the YI1 is a yellowness index at optical path length 200 mm of an article obtained by injection molding of the (meth)acrylic resin composition at a cylinder temperature of 280° C. and a molding cycle of 1 minute; and

the (meth)acrylic resin composition has a melt flow rate under conditions of 230° C. and 3.8 kg load of not less than 25 g/10 min.

[2] The (meth)acrylic resin composition according to [1], wherein the (meth)acrylic resin is composed of 80 to 96% by mass of the structural unit derived from methyl methacrylate and 4 to 20% by mass of the structural unit derived from an acrylic acid ester.
[3] The (meth)acrylic resin composition according to [1] or [2], wherein the YI1 value is 5 or less.
[4] The (meth)acrylic resin composition according to any one of [1] to [3], wherein the (meth)acrylic resin is obtained by bulk polymerization.
[5] A molded article comprising the (meth)acrylic resin composition as described in any one of [1] to [4].
[6] The molded article according to [4], wherein the ratio of resin flow length to thickness is 380 or morer.

### Advantageous Effects of the Invention

The (meth)acrylic resin composition of the present invention is excellent in injection moldability and therefore can give a large-area thin molded article excellent in appearance. The (meth)acrylic resin composition of the present invention can give a large-area thin molded article having little residual distortion and little discoloration at high production efficiency even by injection molding performed at a low cylinder temperature and a high injection pressure.

### EMBODIMENTS FOR CARRYING OUT THE INVENTION

The (meth)acrylic resin composition of the present invention comprises a (meth)acrylic resin.

The (meth)acrylic resin used in the present invention comprises 80 to 100% by mass, preferably 80 to 96% by mass of a structural unit derived from methyl methacrylate relative to the total monomer units. The (meth)acrylic resin used in the present invention also comprises 0 to 20% by mass, preferably 4 to 20% by mass of a structural unit derived from an acrylic acid ester relative to the total monomer units.

Examples of the acrylic acid ester include alkyl acrylates such as methyl acrylate, ethyl acrylate, propyl acrylate, butyl acrylate, and 2-ethylhexyl acrylate; aryl acrylates such as phenyl acrylate; cycloalkyl acrylates such as cyclohexyl acrylate and norbornenyl acrylat, and the like.

The (meth)acrylic resin used in the present invention may comprise a structural unit derived from a monomer other than methyl methacrylate and an acrylic acid ester. Examples of the other monomer include non-crosslinking vinyl monomers having a single polymerizable alkenyl group per molecule, for example, alkyl methacrylates other than methyl methacrylate, such as ethyl methacrylate and butyl methacrylate; aryl methacrylates such as phenyl methacrylate; cycloalkyl methacrylates such as cyclohexyl methacrylate and norbornenyl methacrylate; and other vinyl monomers such as acrylamide, methacrylamide, acrylonitrile, methacrylonitrile, styrene, and α-methylstyrene. The amount of the structural unit derived from such monomer is preferably 10% by mass or less and more preferably 5% by mass or less relative to the total monomer units.

The (meth)acrylic resin has the weight average molecular weight (hereinafter, sometimes abbreviated as Mw) of preferably 35 thousand to 100 thousand, more preferably 40 thousand to 80 thousand, and particularly preferably 45 thousand to 60 thousand. When the Mw is too low, the molded article resulting from the (meth)acrylic resin composition tends to be less resistant to impact and less tough, while when the Mw is too high, the (meth)acrylic resin composition is less fluid and therefore tends to be impaired in its molding processability.

The (meth)acrylic resin has the ratio of weight average molecular weight to number average molecular weight (hereinafter, this ratio is sometimes expressed as molecular weight distribution) of preferably from 1.7 to 2.6, more preferably from 1.7 to 2.3, and particularly preferably from 1.7 to 2.0. When the molecular weight distribution is low, the (meth)acrylic resin composition tends to have less molding processability, while when the molecular weight distribution is high, the molded article resulting from the resin composition tends to be less resistant to impact and therefore tends to be brittle.

The weight average molecular weight and the number average molecular weight here are molecular weights in terms of standard polystyrene measured by GPC (gel permeation chromatography).

The molecular weight and the molecular weight distribution of the (meth)acrylic resin can be controlled by selecting the kinds, the amounts, or the like of a polymerization initiator and a chain transfer agent.

The (meth)acrylic resin can be obtained by polymerization of a monomer mixture comprising at least methyl methacrylate and the acrylic acid ester at the mass ratios described above.

Methyl methacrylate, the acrylic acid ester and the monomers other than these, which are raw material for the (meth)acrylic resin, have the yellowness indices of preferably 2 or less, more preferably 1 or less. When the yellowness indices of these monomers are small enough, the resulting (meth)acrylic resin composition tends to give a molded article having little discoloration at high production efficiency. As described below, a polymerization reaction for producing the (meth)acrylic resin has a moderately high polymerization conversion rate and therefore leaves an unreacted monomer in the polymerization reaction product solution. The unreacted monomer can be recovered from the polymerization reaction product solution and reused in a polymerization reaction. The yellowness index of the recovered monomer is sometimes high due to the heat applied thereto at the time of recovery and/or the like. The recovered monomer is preferably purified by a suitable method to lower the yellowness index. The yellowness index here is a value measured on colorimeter ZE-2000 manufactured by Nippon Denshoku Industries Co., Ltd. in conformity with JIS Z8722.

The polymerization reaction of the monomer mixture is performed preferably by bulk polymerization or solution polymerization, more preferably by bulk polymerization. The polymerization reaction is initiated by addition of a polymerization initiator to the monomer mixture. By adding a chain transfer agent to the monomer mixture where appropriate, the molecular weight and the like of the resulting polymer can be regulated. The amount of dissolved oxygen in the monomer mixture is preferably 10 ppm or less, more preferably 5 ppm or less, further preferably 4 ppm or less, and most preferably 3 ppm or less. When the amount of dissolved oxygen is within this range, the polymerization reaction proceeds smoothly and the resulting molded article tends to be free of silver streak or discoloration.

The polymerization initiator used in the present invention is not particularly limited provided that it generates a reactive radical. Examples thereof include tert-hexylperoxy isopropyl monocarbonate, tert-hexylperoxy 2-ethylhexanoate, 1,1,3,3-tetramethylbutylperoxy 2-ethylhexanoate, tert-butylperoxy pivalate, tert-hexylperoxy pivalate, tert-butylperoxy neodecanoate, tert-hexylperoxy neodecanoate, 1,1,3,3-tetramethylbutylperoxy neodecanoate, 1,1-bis(tert-hexylperoxy)cyclohexane, benzoyl peroxide, 3,5,5-trimethylhexanoyl peroxide, lauroyl peroxide, 2,2′-azobis(2-methylpropionitrile), 2,2′-azobis(2-methylbutyronitrile), and dimethyl 2,2′-azobis(2-methylpropionate). Among these, tert-hexylperoxy 2-ethylhexanoate, 1,1-bis(tert-hexylperoxy)cyclohexane, and dimethyl 2,2′-azobis(2-methylpropionate) are preferable.

Among these polymerization initiators, one having a 1-hour half-life temperature of preferably 60 to 140° C. is preferred, one having a 1-hour half-life temperature of more preferably 80 to 120° C. is preferred. As for the polymerization initiator for use in bulk polymerization, the hydrogen abstraction capacity thereof is preferably 20% or less, more preferably 10% or less, and further preferably 5% or less. The polymerization initiator can be used alone or in combination of two or more of these. The additive amount, the addition method and the like of the polymerization initiator are not particularly limited and may be selected, as appropriate, depending on the purpose that the polymerization initiator serves. The amount of the polymerization initiator for use in bulk polymerization, for example, is preferably 0.0001 to 0.02 part by mass and more preferably 0.001 to 0.01 part by mass relative to 100 parts by mass of the monomer mixture.

The hydrogen abstraction capacity can be found, for example, in the Technical data from the manufacturer of the polymerization initiator (Non-patent Document 1, for example), or can be measured by radical trapping using an α-methylstyrene dimer, in other words, by α-methylstyrene dimer trapping. The measurement is generally carried out as follows. The polymerization initiator is cleaved in the co-presence of an α-methylstyrene dimer serving as a radical-trapping agent to give radical fragments. Among the resulting radical fragments, a radical fragment with low hydrogen abstraction capacity adds to the double bond of the α-methylstyrene dimer to be trapped by the α-methylstyrene dimer. On the other hand, a radical fragment with high hydrogen abstraction capacity abstracts hydrogen from cyclohexane to generate a cyclohexyl radical, the cyclohexyl radical then adds to the double bond of the α-methylstyrene dimer to be trapped by the α-methylstyrene dimer to give a cyclohexane-trapped product. The cyclohexane or the cyclohexane-trapped product is quantified, and the result is used to determine the ratio (molar fraction) of the amount of the radical fragment with high hydrogen abstraction capacity to the theoretical amount of radical fragment production. The ratio serves as hydrogen abstraction capacity.

Examples of the chain transfer agent include alkylmercaptans such as n-octyl mercaptan, n-dodecyl mercaptan, tert-dodecyl mercaptan, 1,4-butanedithiol, 1,6-hexanedithiol, ethylene glycol bisthiopropionate, butanediol bisthioglycolate, butanediol bisthiopropionate, hexanediol bisthioglycolate, hexanediol bisthiopropionate, trimethylolpropane tris-(β-thiopropionate), and pentaerythritol tetrakisthiopropionate; α-methylstyrene dimers; and terpinolene. Among these, monofunctional alkylmercaptans such as n-octyl mercaptan and n-dodecyl mercaptan are preferable. The chain transfer agent can be used alone or in combination of two or more of these. The amount of the chain transfer agent used is preferably 0.1 to 1 part by mass, more preferably 0.2 to 0.8 part by mass, and further preferably 0.3 to 0.6 part by mass, relative to 100 parts by mass of the monomer mixture. When the amount of the chain transfer agent used is too small, the proportion of thiol terminals in all the terminals of the resulting (meth)acrylic resin decreases, which tends to result in poor thermal stability. On the other hand, when the amount of the chain transfer agent used is too large, the molecular weight of the resulting (meth)acrylic resin decreases and therefore the mechanical strength thereof tends to decrease.

The solvent used in solution polymerization is not particularly limited provided that it is capable of dissolving the raw material monomer mixture and the resulting methacrylic resin, and is preferably an aromatic hydrocarbon such as benzene, toluene, and ethylbenzene. The solvent can be used alone or in combination of two or more of these. The amount of the solvent used is preferably 0 to 100 parts by mass and more preferably 0 to 90 parts by mass relative to 100 parts by mass of the monomer mixture. As the amount of the solvent used increases, the reaction product solution becomes less viscous to give better handling but productivity tends to decrease.

The polymerization conversion rate for the monomer mixture is regulated to fall within the range of preferably 20 to 80% by mass, more preferably 30 to 70% by mass, and further preferably 35 to 65% by mass. With the polymerization conversion rate being in the range, the difference between YI4 and YI1 is easily regulated to fall within the range described below. When the polymerization conversion rate is too high, stirring force required to raise the viscosity tends to be large, while when the polymerization conversion rate is too low, devolatilization tends to proceed insufficiently and the resulting (meth)acrylic resin composition tends to give a molded article having defective appearance such as silver streak.

Examples of the apparatus used for bulk polymerization or solution polymerization include a tank reactor equipped with a stirrer, a tube reactor equipped with a stirrer, and a tube reactor capable of stirring statically. One or more of these apparatuses may be used, or two or more of different reactors may be used in combination. The apparatus may operate in either batch-mode or continuous flow mode. The stirrer used can be selected depending on the operating mode of the reactor. Examples of the stirrer include a dynamic stirrer and a static stirrer. The most preferable apparatus to give the (meth)acrylic resin used in the present invention is one having at least one continuous-flow tank reactor. A plurality of continuous-flow tank reactors, when used, may be connected in series or in parallel.

The tank reactor usually has a stirring means for stirring liquid in the reaction tank, an inlet for supplying the monomer mixture, auxiliary materials for polymerization, and the like to the reaction tank, and an outlet for extracting the reaction product from the reaction tank. In a continuous-flow reaction, the amount of supply to the reaction tank and the amount of extract from the reaction tank are kept in balance so as to maintain approximately the same amount of liquid in the reaction tank. The amount of liquid in the reaction tank is preferably ¼ to ¾, more preferably ⅓ to ⅔ of the inner volume of the reaction tank.

Examples of the stirring means include a Maxblend stirring device, a stirring device in which a grid-like blade rotates about a vertical rotation axis located at the center, a propeller-driven stirring device, and a screw stirring device. Among these, a Maxblend stirring device is preferably used in terms of homogeneous mixing.

Methyl methacrylate, the acrylic acid ester, the polymerization initiator, and the chain transfer agent may be fed to the reaction tank after all of these are mixed together or may be fed to the reaction tank separately, and preferable in the present invention is feeding to the reaction tank after all of these are mixed together.

Mixing of methyl methacrylate, the acrylic acid ester, the polymerization initiator, and the chain transfer agent is preferably performed in an inert atmosphere such as in nitrogen gas. In order to allow the continuous-flow operation to proceed smoothly, it is preferable to feed methyl methacrylate, the acrylic acid ester, the polymerization initiator, and the chain transfer agent respectively from a storage tank that stores each through a tube to a mixer provided at the front of the reaction tank for continuous mixing, and then supply the resulting mixture continuously to the reaction tank. The mixer can have a dynamic stirrer or a static stirrer.

The temperature during the polymerization reaction is preferably 100 to 150° C., and more preferably 110 to 140° C. When the polymerization temperature is within this range, the productivity is high and the difference between YI4 and YI1 is easily regulated to fall within the range of the present invention.

The duration of the polymerization reaction is preferably 0.5 to 4 hours, more preferably 1.5 to 3.5 hours, and particularly preferably 1.5 to 3 hours. When a continuous-flow reactor is used, the duration of the polymerization reaction is the average residence time in the reactor. When the duration of the polymerization reaction is within the range, the difference between YI4 and YI1 is easily regulated to fall within the range of the present invention. Polymerization is preferably carried out under an atmosphere of inert gas such as nitrogen gas.

After the completion of polymerization, an unreacted monomer and a solvent are removed where appropriate. The method for removal is not particularly limited and is preferably heat devolatilization. Examples of the method for devolatilization include the equilibrium flash process and the adiabatic flash process. Particularly in the adiabatic flash process, the temperature is preferably 200 to 280° C., and more preferably 220 to 260° C. and the heating time is preferably 0.3 to 5 minutes, more preferably 0.4 to 3 minutes, and further preferably 0.5 to 2 minutes, in devolatilization. When the devolatilization temperature and the heating time are within the ranges, production of dimers, trimers, and the like to cause heat discoloration is inhibited and therefore the difference between YI4 and YI1 is easily regulated to fall within the range of the present invention.

The amount of the (meth)acrylic resin in the (meth)acrylic resin composition of the present invention is preferably 99.5% by mass or more, and more preferably 99.8% by mass or more relative to the whole (meth)acrylic resin composition.

By regulating the yellowness indices of the raw material monomers, the amounts of substances that cause discoloration, such as unreacted monomers, dimers, and trimers in the (meth)acrylic resin, the terminal structures of the molecular chains, and the like, in the manners described above, it is possible to easily regulate the difference between YI4 and YI1 to fall within the range of the present invention.

The (meth)acrylic resin composition of the present invention may also contain various additives, where appropriate, at amounts of preferably 0.5% by mass or less, and more preferably 0.2% by mass or less. When the contents of the additives are too high, the resulting molded article sometimes has defective appearance such as silver streak.

Examples of the additives include an antioxidant, a thermal degradation inhibitor, an ultraviolet absorber, a light stabilizer, a lubricant, a mold release agent, a polymer processing aid, an antistatic agent, a flame retardant, a dye and a pigment, a light dispersing agent, an organic coloring agent, a delustering agent, an impact resistance modifier, and a fluorescent substance.

An antioxidant by itself has an effect to prevent oxidative degradation of a resin caused in the presence of oxygen. Examples thereof include phosphorus-based antioxidants, hindered phenol antioxidants, and thioether antioxidants. The antioxidant can be used alone or in combination of two or more of these. Among these, from the viewpoint of the effect to prevent optical properties from being impaired due to discoloration, phosphorus-based antioxidants and hindered phenol antioxidants are preferable, and the concurrent use of a phosphorus-based antioxidant and a hindered phenol antioxidant is more preferable.

When a phosphorus-based antioxidant and a hindered phenol antioxidant are concurrently used, the proportion therebetween is not particularly limited and is preferably 1/5 to 2/1 and more preferably 1/2 to 1/1 as the mass ratio of phosphorus-based antioxidant/hindered phenol antioxidant.

As the phosphorus-based antioxidant, 2,2-methylenebis(4,6-di-tert-butylphenyl)octyl phosphite (manufactured by Asahi Denka, trade name: ADK STAB HP-10) and tris(2,4-di-tert-butylphenyl)phosphite (manufactured by Ciba Specialty Chemicals, trade name: IRGAFOS 168) are preferable, for example.

As the hindered phenol antioxidant, pentaerythrityl-tetrakis[3-(3,5-di-tert-butyl-4-hydroxyphenyl)propionate] (manufactured by Ciba Specialty Chemicals, trade name: IRGANOX 1010) and octadecyl-3-(3,5-di-tert-butyl-4-hydroxyphenyl)propionate (manufactured by Ciba Specialty Chemicals, trade name: IRGANOX 1076) are preferable, for example.

A thermal degradation inhibitor can trap a polymer radical that is generated at high heat in the practical absence of oxygen and therefore can prevent thermal degradation of a resin.

As the thermal degradation inhibitor, 2-tert-butyl-6-(3′-tert-butyl-5′-methyl-hydroxybenzyl)-4-methylphenyl acrylate (manufactured by Sumitomo Chemical Company, Limited, trade name: SUMILIZER GM) and 2,4-di-tert-amyl-6-(3′,5′-di-tert-amyl-2′-hydroxy-α-methylbenzyl)phenyl acrylate (manufactured by Sumitomo Chemical Company, Limited, trade name: SUMILIZER GS) are preferable, for example.

An ultraviolet absorber is a compound capable of absorbing ultraviolet light. An ultraviolet absorber is thought to have primarily function to convert light energy into thermal energy.

Examples of the ultraviolet absorber include benzophenones, benzotriazoles, triazines, benzoates, salicylates, cyanoacrylates, oxalic anilides, malonic acid esters, and formamidines. The ultraviolet absorber can be used alone or in combination of two or more of these.

Preferable among these are benzotriazoles and ultraviolet absorbers having the maximum molar absorption coefficient εₘₐₓ at a wavelength of 380 to 450 nm of 1200 dm³·mol⁻¹cm⁻¹ or less.

Benzotriazoles effectively inhibit optical properties from being impaired due to, for example, discoloration caused by ultraviolet radiation, and therefore are preferable as an ultraviolet absorber for use when the (meth)acrylic resin composition of the present invention is used in applications where the properties described above are required.

As the benzotriazoles, 2-(2H-benzotriazol-2-yl)-4-(1,1,3,3-tetramethylbutyl) phenol (manufactured by Ciba Specialty Chemicals, trade name: TINUVIN 329) and 2-(2H-benzotriazol-2-yl)-4,6-bis(1-methyl-1-phenylethyl)phenol (manufactured by Ciba Specialty Chemicals, trade name: TINUVIN 234) are preferable, for example.

The ultraviolet absorbers having the maximum molar absorption coefficient εₘₐₓ at a wavelength of 380 to 450 nm of 1200 dm³·mol⁻¹cm⁻¹ or less can inhibit yellowing of the resulting molded article. Such ultraviolet absorbers are preferable as an ultraviolet absorber for use when the (meth)acrylic resin composition of the present invention is used in applications where the properties described above are required.

The maximum molar absorption coefficient, εₘₐₓ, of an ultraviolet absorber is measured as follows. To 1 L of cyclohexane, 10.00 mg of an ultraviolet absorber is added and dissolved until no undissolved matter is visually observed. The resulting solution is poured into a quartz glass cell of 1 cm×1 cm×3 cm and the absorbance at a wavelength of 380 to 450 nm is measured by U-3410 spectrophotometer manufactured by Hitachi, Ltd. Using of The molecular weight (Mw) of the ultraviolet absorber and the maximum absorbance (Aₘₐₓ) thus measured, the maximum molar absorption coefficient, εₘₐₓ, is calculated by formula:

εₘₐₓ=[Aₘₐₓ/(10×10⁻³)]×Mw.

Examples of the ultraviolet absorbers having the maximum molar absorption coefficient εₘₐₓ at a wavelength of 380 to 450 nm of 1200 dm³·mol⁻¹cm⁻¹ or less include 2-ethyl-2′-ethoxy-oxalic anilide (manufactured by Clariant (Japan) K.K., trade name: Sanduvor VSU).

Among these ultraviolet absorbers, from the viewpoint of inhibiting degradation of a resin caused by ultraviolet radiation, benzotriazoles are preferably used.

A light stabilizer is a compound that is thought to have primarily function to trap a radical generated by light oxidation. Preferable examples of the light stabilizer include hindered amines such as compounds having a 2,2,6,6-tetraalkylpiperidine skeleton.

A mold release agent is a compound that functions to facilitate release of a molded article from a mold. Examples of the mold release agent include higher alcohols such as cetyl alcohol, stearyl alcohol and the like; and glycerol higher fatty acid esters such as stearic acid monoglyceride and stearic acid diglyceride. The mold release agent in the present invention is preferably a combination of a higher alcohol and a glycerol fatty acid monoester. When a higher alcohol and a glycerol fatty acid monoester are used in combination, the proportion therebetween is not particularly limited and is preferably 2.5/1 to 3.5/1 and more preferably 2.8/1 to 3.2/1 as the mass ratio of higher alcohol/glycerol fatty acid monoester.

A polymer processing aid is a compound that exhibits its effect in molding a (meth)acrylic resin composition to ensure accurate thickness and give a thin product. A polymer processing aid is usually a polymer particle with a particle diameter of 0.05 to 0.5 μm that can be produced by emulsion polymerization.

The polymer particle may be a monolayer particle of a polymer having a single composition ratio and a single limiting viscosity or may be a multilayer particle of two or more polymers different in the composition ratio or the limiting viscosity. Among these, preferable examples thereof include particles having a two-layer structure where the inner layer is a polymer layer with low limiting viscosity and the outer layer is a polymer layer with high limiting viscosity of 5 dl/g or more.

The polymer processing aid preferably has limiting viscosity of 3 to 6 dl/g. When the limiting viscosity is too low, the effect to improve moldability is low, while when the limiting viscosity is too high, the melt fluidity of the (meth)acrylic resin composition tends to decrease.

The (meth)acrylic resin composition of the present invention may contain an impact resistance modifier. Examples of the impact resistance modifier include core-shell modifiers containing acrylic rubber or diene rubber as a core layer component; and modifiers containing a plurality of rubber particles.

Preferable as the organic coloring agent is a compound that functions to convert ultraviolet light, which is thought to be harmful to a resin, into visible light.

Examples of the light dispersing agent and the delustering agent include glass microparticles, polysiloxane-based crosslinked microparticles, crosslinked polymer microparticles, talc, calcium carbonate, and barium sulfate.

Examples of the fluorescent substance include fluorescent pigments, fluorescent dyes, fluorescent white dyes, fluorescent brighteners, and fluorescent bleaching agents.

These additives may be added to the polymerization reaction solution during production of the (meth)acrylic resin or may be added to the (meth)acrylic resin after produced by a polymerization reaction.

As for the (meth)acrylic resin composition of the present invention, the difference between YI4 and YI1 is 3 or less, preferably 2.5 or less, and more preferably 2 or less, in which the YI4 is the yellowness index for optical path length of 200 mm of an article resulting from injection molding performed at a cylinder temperature of 280° C. and a molding cycle of 4 minutes and the YI1 is the yellowness index for optical path length of 200 mm of an article resulting from injection molding performed at a cylinder temperature of 280° C. and a molding cycle of 1 minute. When the difference between YI4 and YI1 exceeds 3, transmittance decreases to cause, for example, a decrease in luminance and/or a change in color of a light guide plate used in a backlight unit of a liquid crystal display or the like.

The YI1, the yellowness index for optical path length of 200 mm of an article resulting from injection molding performed at a cylinder temperature of 280° C. and a molding cycle of 1 minute is preferably 5 or less, more preferably 4 or less, and further preferably 3 or less. The yellowness index here is a value measured on colorimeter ZE-2000 manufactured by Nippon Denshoku Industries Co., Ltd. in conformity with JIS Z8722.

The melt flow rate of the (meth)acrylic resin composition of the present invention under conditions of 230° C. and 3.8 kg load is not lower than 25 g/10 minutes, preferably 25 to 35 g/10 minutes, and more preferably 28 to 32 g/10 minutes. The melt flow rate here is a value measured in conformity with JIS K7210 under conditions of 230° C., 3.8 kg load, and 10 minutes.

The (meth)acrylic resin composition of the present invention can be molded (by heating/melting molding) with a conventionally known molding method such as injection molding, compression molding, extrusion molding, and vacuum forming to give various molded articles. In particular, the (meth)acrylic resin composition of the present invention can give a large-area thin molded article having little residual distortion and little discoloration at high production efficiency even by injection molding performed at a low cylinder temperature and a high injection pressure.

Examples of the molded article formed from the (meth)acrylic resin composition of the present invention include parts of advertising signs such as advertising pillars, sign stands, projecting signs, door-top signs, and roof-top signs; display parts such as showcases, dividers, and store display parts; lighting fixture parts such as fluorescent lamp covers, mood lighting covers, lampshades, and parts of luminous ceilings, luminous walls, and chandeliers; parts of interior furnishings such as pendants and mirrors; building parts such as doors, domes, safety window panes, partitions, stair skirting boards, balcony skirting boards, and roofs of buildings for recreational use; carrier-related parts such as aircraft windshields, pilot visors, motorcycle windshields, motorboat windshields, visors for buses, side visors for automobiles, rear visors, head wings, and headlight covers; electronics parts such as nameplates for audiovisuals, stereo covers, television protection masks, and parts of vending machines; parts of medical equipment and devices such as incubators and X-ray machines; parts related to equipment and instruments, such as machinery covers, gauge covers, parts of experiment instruments, rulers, dials, and view windows; optics-related parts such as protective plates for liquid crystal, light guide plates, light guide films, Fresnel lenses, lenticular lenses, and front plates and light dispersing plates of various displays; traffic-related parts such as traffic signs, direction boards, curved mirrors, and noise barriers; film parts such as surface materials for automotive interior, surface materials of mobile phones, and marking films; appliance parts such as lid materials and control panels of washers and top panels of rice cookers; and other items such as greenhouses, large aquariums and water tanks, box-shaped aquariums and water tanks, clock panels, bathtubs, sanitary wares, desk mats, gaming parts, toys, and welding masks for facial protection. Among these, thin injection-molded articles with a thickness of 1 mm or less are preferable and large-area thin injection-molded articles with a ratio of resin flow length relative to thickness of 380 or more are particularly preferable. Preferable examples of the large-area thin injection-molded articles include light guide plates.

The resin flow length here is the distance from the gate of an injection mold to the portion of the interior wall of a mold farthest from the gate. The resin flow length in an injection mold having a film gate is the distance from the portion of the injection mold where a runner and a sprue are installed to the portion of the interior wall of the mold farthest from the installation portion.

The gate of a mold for use to give the molded article according to the present invention is preferably a film gate. The film gate is fabricated by cutting with a cutter and finishing with a router and/or the like. On a mold for giving a light guide plate used in a liquid crystal display, the gate is preferably provided in the end face on which no light source is to be installed.

### EXAMPLES

The present invention will be described more specifically by examples and comparative examples. The present invention is, however, not limited to these examples. The present invention includes all the embodiments in which requirements on technical characteristics such as properties, configurations, processes, and applications described above are optionally combined.

Measurement and the like of the physical properties in the examples and the comparative examples is carried out as follows.

### (Yellowness Index of Monomer Mixture)

A monomer mixture was placed in a quartz cell of 10 mm square and 45 mm long, and the transmittance for a width of 10 mm was measured on colorimeter ZE-2000 manufactured by Nippon Denshoku Industries Co., Ltd. The resulting values were used to determine XYZ values according to a method in JIS Z8722, and then yellowness index (YI) was determined by calculation according to a method in JIS K7105.

### (Polymerization Conversion Rate)

Analysis was performed on gas chromatograph GC-14A manufactured by Shimadzu Corporation to which a column, INERT CAP 1 (df=0.4 μm, 0.25 mm I.D.×60 m) manufactured by GL Sciences Inc., was connected, at an injection temperature of 180° C. and a detector temperature of 180° C., where the column temperature was set at 60° C. (maintained for 5 minutes) and was then raised at a rate of 10° C./minute to achieve 200° C. (maintained for 10 minutes). Based on this analysis, calculation was performed.

### (Melt Flow Rate)

Measurement was carried out in conformity with JIS K7210 under conditions of 230° C., 3.8 kg load, and 10 minutes.

### (YI4 and YI1)

Flat plate L1 was made with an injection molding machine J-110EL III manufactured by The Japan Steel Works, Ltd. using a mold for flat plate molding application of 200-mm long, 60-mm wide, and 6-mm thick at a cylinder temperature of 280° C. and a mold temperature of 60° C. at a molding cycle of 1 minute. Subsequently, flat plate L2 was fabricated in the same manner except that the molding cycle was 4 minutes.

The transmittance was measured on spectrophotometer PC-2200 manufactured by Shimadzu Corporation with standard illuminant C for optical path length of 200 mm (the length of either of plates L1 and L2) at a wavelength ranging from 340 nm to 700 nm with 1-nm increments. The reading values were used to determine XYZ values according to a method in JIS Z8722, and then yellowness index (YI) was determined by calculation according to a method in JIS K7105. The yellowness index of the flat plate L4 is called YI4, while the yellowness index of the flat plate L1 is called YI1.

### (Injection Moldability)

A (meth)acrylic resin composition pellet was subjected to injection molding with injection molding machine SE-180DU-HP manufactured by Sumitomo Heavy Industries, Ltd. at a cylinder temperature of 280° C., a mold temperature of 75° C., and a molding cycle of 1 minute to fabricate flat plate S of 205-mm long, 160-mm wide, and 0.5-mm thick. The ratio of resin flow length (190 mm) to thickness was 380.

The appearance of flat plate S was observed by the naked eye. Moldability was evaluated based on the presence or absence of defects such as sink marks and silver streak.

### (Change in Dimensions)

A thermostatic chamber at 60° C. in which the flat plate S was left in the atmosphere for 4 hours. The flat plate was taken out of the thermostatic chamber and the longitudinal dimension thereof was measured. Using the longitudinal dimension thereof measured before placement in the thermostatic chamber, change in dimensions was calculated.

### (Transmittance)

A specimen was cutout from the flat plate S so that optical path length was 200 mm, and transmittance at a wavelength of 435 nm for optical path length of 200 mm was measured.

### Example 1

To an autoclave equipped with a stirrer and a sampling tube, 92 parts by mass of purified methyl methacrylate and 8 parts by mass of methyl acrylate were fed so as to prepare a monomer mixture. The yellowness index of the monomer mixture was 0.9. To the monomer mixture, 0.007 part by mass of a polymerization initiator (2,2′-azobis(2-methylpropionitrile) (AIBN), hydrogen abstraction capacity: 1%, 1-hour half-life temperature: 83° C.) and 0.45 part by mass of a chain transfer agent (n-octyl mercaptan) were added for dissolution to give a raw material solution. Nitrogen gas was used to purge oxygen gas from the production apparatus.

The raw material solution was discharged from the autoclave at a constant rate to feed a continuous-flow tank reactor controlled at a temperature of 140° C. at a constant flow rate so as to ensure the average residence time to be 120 minutes, for bulk polymerization. The reaction product solution was sampled through a sampling tube in the reactor and was measured by gas chromatography to give a polymerization conversion rate of 55% by mass.

The solution being discharged from the reactor at a constant flow rate was heated with a heater to 230° C. over 1 minute and was then fed at a constant flow rate to a twin screw extruder controlled at 250° C. In the twin screw extruder, volatile matter mainly composed of unreacted monomers was separated and removed and a resin component was extruded to obtain a strand thereof. The strand was cut with a pelletizer to give a pellet of a (meth)acrylic resin composition. The content of the remaining volatile matter was 0.1% by mass. The results of evaluation of the resulting (meth)acrylic resin composition are shown in Table 1.

### Example 2

The (meth)acrylic resin composition of the present invention was obtained as a pellet in the same manner as in Example 1 except that the amount of n-octyl mercaptan was changed into 0.42 part by mass. Various physical properties of the (meth)acrylic resin composition as a pellet were evaluated in the same manner as in Example 1. The results are shown in Table 1.

### Comparative Example 1

The (meth)acrylic resin composition was obtained as a pellet in the same manner as in Example 1 except that the amount of methyl methacrylate was changed into 95 parts by mass and the amount of methyl acrylate was changed into 5 parts by mass in the monomer mixture, and the amount of n-octyl mercaptan was changed into 0.35 part by mass. Various physical properties of the (meth)acrylic resin composition as a pellet were evaluated in the same manner as in Example 1. The results are shown in Table 1. At the time of molding flat plate S, the fluidity of the (meth)acrylic resin composition was not enough to fill up the mold.

### Comparative Example 2

The (meth)acrylic resin composition was obtained as a pellet in the same manner as in Example 1 except that the amount of n-octyl mercaptan was changed into 0.42 part by mass and the monomer mixture used had a yellowness index of 4.8. Various physical properties of the (meth)acrylic resin composition as a pellet were measured in the same manner as in Example 1. The results are shown in Table 1.

### Comparative Example 3

The (meth)acrylic resin composition was obtained as a pellet in the same manner as in Example 1 except that the amount of AIBN was changed into 0.0075 part by mass, the amount of n-octyl mercaptan was changed into 0.4 part by mass, the polymerization temperature was 175° C., and the average residence time was 1 hour. Various physical properties of the (meth)acrylic resin composition as a pellet were measured in the same manner as in Example 1. The results are shown in Table 1.

### Comparative Example 4

The (meth)acrylic resin composition was obtained as a pellet in the same manner as in Example 1 except that the amount of AIBN was changed into 0.0075 part by mass, the amount of n-octyl mercaptan was changed into 0.17 part by mass, the polymerization temperature was 175° C., the average residence time was 1 hour, and 0.002 part by mass of di-tert-dodecyl disulfide was added as an additive. Various physical properties of the (meth)acrylic resin composition as a pellet were evaluated in the same manner as in Example 1. The results are shown in Table 1. At the time of molding flat plate S, the fluidity of the (meth)acrylic resin composition was not enough to fill up the mold.

TABLE 1

| | Ex. | | Comp. Ex. | | | |
|---|---|---|---|---|---|---|
| | 1 | 2 | 1 | 2 | 3 | 4 |
| [Monomer mixtrue] | | | | | | |
| Methyl methacrylate | 92 | 92 | 95 | 92 | 92 | 96 |
| [parts by mass] | | | | | | |
| Methyl acrylate | 8 | 8 | 5 | 8 | 8 | 4 |
| [parts by mass] | | | | | | |
| Monomer YI | 0.9 | 0.9 | 0.9 | 4.8 | 0.9 | 0.9 |
| [Polymerization initiator] | | | | | | |
| AIBN [part by mass] | 0.007 | 0.007 | 0.007 | 0.007 | 0.075 | 0.075 |
| [Chain transfer agent] | | | | | | |
| N-octyl mercaptan | 0.45 | 0.42 | 0.35 | 0.42 | 0.40 | 0.17 |
| [part by mass] | | | | | | |
| [Additive] | | | | | | |
| Di-t-dodecyl sulfide | | | | | | 0.002 |
| [part by mass] | | | | | | |
| [Polymerization conditions] | | | | | | |
| Polymerization temperature [° C.] | 140 | 140 | 140 | 140 | 175 | 175 |
| Average residence time [hr] | 2 | 2 | 2 | 2 | 1 | 1 |
| Polymerization | 55 | 55 | 53 | 55 | 55 | 56 |
| conversion rate [%] | | | | | | |
| Evaluation of physical | | | | | | |
| properties of resin composition | | | | | | |
| Melt flow rate [g/10 min.] | 30 | 25 | 10 | 25 | 25 | 3 |
| Difference between YI4 and YI1 | 1.9 | 2.0 | 2.8 | 7.5 | 8.8 | 4.8 |
| YI1 | 2.9 | 3.0 | 4.5 | 6.0 | 7.2 | 10.0 |
| Injection moldability | Excel. | Excel. | Poor | Excel. | Excel. | Poor |
| Change in dimensions [%] | 0.1 | 0.4 | — | 0.4 | 0.4 | — |
| Light Transmittance [%] | 85 | 85 | — | 70 | 70 | — |

As shown in Table 1, the (meth)acrylic resin composition of the present invention is excellent in injection moldability and therefore can give a large-area thin molded article excellent in appearance. From above, it was proven that the (meth)acrylic resin composition of the present invention can give a large-area thin molded article having little residual distortion and little discoloration at high production efficiency even by injection molding performed at a low cylinder temperature and a high pressure.

1. A (meth)acrylic resin composition comprising
not less than 99.5% by mass of (meth)acrylic resin which comprises 80 to 100% by mass of a structural unit derived from methyl methacrylate and 0 to 20% by mass of a structural unit derived from an acrylic acid ester,
wherein
a difference between YI4 and YI1 is not more than 3, in which the YI4 is a yellowness index at optical path length 200 mm of an article obtained by injection molding of the (meth)acrylic resin composition at a cylinder temperature of 280° C. and a molding cycle of 4 minutes, and the YI1 is a yellowness index at optical path length 200 mm of an article obtained by injection molding of the (meth)acrylic resin composition at a cylinder temperature of 280° C. and a molding cycle of 1 minute; and
the (meth)acrylic resin composition has a melt flow rate at 230° C. and 3.8 kg load of not less than 25 g/10 min.

2. The (meth)acrylic resin composition according to claim 1, wherein the (meth)acrylic resin comprises 80 to 96% by mass of the structural unit derived from methyl methacrylate and 4 to 20% by mass of the structural unit derived from acrylic acid ester.

3. The (meth)acrylic resin composition according to claim 1, wherein the YI1 is not more than 5.

4. The (meth)acrylic resin composition according to claim 2, wherein the YI1 is not more than 5.

5. The (meth)acrylic resin composition according to claim 1, wherein the (meth)acrylic resin is obtained by bulk polymerization.

6. The (meth)acrylic resin composition according to claim 2, wherein the (meth)acrylic resin is obtained by bulk polymerization.

7. The (meth)acrylic resin composition according to claim 3, wherein the (meth)acrylic resin is obtained by bulk polymerization.

8. The (meth)acrylic resin composition according to claim 4, wherein the (meth)acrylic resin is obtained by bulk polymerization.

9. A molded article comprising the (meth)acrylic resin composition as claimed in claim 1.

10. A molded article comprising the (meth)acrylic resin composition as claimed in claim 2.

11. A molded article comprising the (meth)acrylic resin composition as claimed in claim 3.

12. A molded article comprising the (meth)acrylic resin composition as claimed in claim 4.

13. A molded article comprising the (meth)acrylic resin composition as claimed in claim 5.

14. A molded article comprising the (meth)acrylic resin composition as claimed in claim 6.

15. A molded article comprising the (meth)acrylic resin composition as claimed in claim 7.

16. A molded article comprising the (meth)acrylic resin composition as claimed in claim 8.

17. The molded article according to claim 9, wherein a ratio of resin flow length to thickness is not less than 380.

18. The molded article according to claim 10, wherein a ratio of resin flow length to thickness is not less than 380.

19. The molded article according to claim 11, wherein a ratio of resin flow length to thickness is not less than 380.

20. The molded article according to claim 12, wherein a ratio of resin flow length to thickness is not less than 380.
